(19) United States
(12) Patent Application Publication
(10) Pub. No.: US 2006/0150520 A1
(43) Pub. Date: Jul. 13, 2006

(54) Automatic opening and closing system for opening and closing a window by automatically locking and/or unlocking a lock section of a window and by using a sensor

(75) Inventor: Yukio Hamazaki, Okazaki-City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HAMADA KOUSYOU CO., LTD., Okazaki-City (JP)

(21) Appl. No.: 11/302,515

(22) Filed: Dec. 14, 2005

(30) Foreign Application Priority Data
Dec. 17, 2004 (JP) 2004-366388
Apr. 26, 2005 (JP) 2005-127983

(51) Int. Cl. E05B 55/00

(52) U.S. Cl. 49/449

(57) ABSTRACT

An automatic opening and closing system for opening and closing a window by automatically locking and unlocking a lock section of the window and by using a sensor, with a lock locking and unlocking mechanism for locking and unlocking a window of a building Apprising a stand fitted into a hole opened in one window frame, a lock section constituted by a lock body provided at this stand, a lock piece engaging with the lock section provided at the remaining frame, and a first controller for moving the lock piece, with the lock locking and unlocking mechanism actuated by operation of the first controller so as to lock and unlock the window, and the window opening and closing mechanism for opening and/or closing the window comprising a fitting lug body fitted to the frame, a stopping lug provided at the fitting lug body, a drive section such as a motor etc. capable of forward and reverse motion provided at the fitting lug body, a drive section body axially installed at the drive section and coming into contact with the window frame, and a second controller for actuating the drive section, with the drive section being actuated by operation of the second controller so as to open and close the window.

### BACKGROUND OF THE INVENTION

1. Field of the Invention

The present invention relates to an automatic window opening/closing system for achieving automatic locking and/or unlocking of a window using a lock section, and opening and/or closing a window using the action of sensors such as a rainwater sensor, temperature sensor, and wind sensor etc.

2. Description of the Related Art

In the related art, windows are always present in a house (dwelling), with these windows typically always being flush with the building frame of the house. With Western-style houses, many types of special configurations exist for such windows, such as bay windows and skylights etc. (hereinafter taken to be “windows”). The opening and closing of windows may take place in daily life in order to ventilate a roan, to adjust the temperature, to block out wind and rain, or to get rid of smoke, etc. On the other hand, locking and covering of the windows is also necessary from the point of view of crime prevention. However, there are also cases where a window is left open or covered as a result of forgetfulness with a person then going out or going to bed, etc. In this event, there are problems where, for example, processing for the cases of dramatic changes in the weather, or where covering becomes necessary during sleeping cannot be implemented, and processing for when opening and/or covering over from the point of view of health or physical conditions etc. cannot be achieved. In particular, with people other than able bodied people such as physically disabled people, provisions have to be made for the act of locking and unlocking and/or opening and closing etc. of this type of window. As a result of this viewpoint, a large number of applications have been made for inventions for devices for automatically locking and unlocking and/or opening and closing windows automatically based on fixed conditions.

Document 1 is Japanese Laid-open Patent Publication No. 2004-250946 “Double-sliding Window (Opening/Closing Apparatus”. At the time of closing the window, an electric motor of a drive control mechanism is driven as a result of operation of a remote control unit so as to displace the window in a closing direction via a one-way clutch. At the time of opening the window, the configuration is such that it is possible to open and close the window by displacing the window in an opening direction using resilient force of a main spring at the tine of opening the window as the result of an operation of the remote control unit. Closing through manual driving is then possible at the time of breakdown or power failure by utilizing a mechanism such as a one-way clutch etc.

Document 2 is Japanese Laid-open Patent Publication No. 2000-310068, “Window Lock Automatic Opening Apparatus”, provided with an automatic locking mechanism for automatically locking a window locking section, an automatic opening mechanism for automatically opening the window, and a control circuit for automatically opening the window after automatic locking of the window locking section.

Further, document 3 is Japanese laid-open patent publication 2004-137851, “Lock Apparatus for use with Double-sliding Doors”, which is provided with a lock apparatus body and locking member provided in the vicinity of a covering section of a double-sliding door, a locking rod, rising and setting at the locking section provided at the locking apparatus body, for locking and unlocking the lock member, control means such as a motor etc. for operating this locking rod, and vibration detection means for detecting abnormal vibrations of the double-sliding door and issuing abnormal signals. An alarm is issued as a result of this abnormal signal, and it is possible to suppress the occurrence of an intruder breaking the glass and making an intrusion.

Further, document 4 is Japanese Patent Laid-open Publication No. Hei. 7-26569, “Sliding-type Automatically Opening and Closing Window”, provided with an operation mechanism of a remote control circuit connected to a power supply, a timer, and a drive motor etc., a box housing the remote control circuit and the operation mechanism, a sensor such as a humidity sensor for detecting rain, and an outer window frame, and a window opening/closing section fie to a frame work. This operation mechanism operates as a result of remote control operation and/or sensors, remote circuits, and timers, so as to be capable of automatically opening and closing this window.

### SUMMARY OF THE INVENTION

Document 1 is capable of automatically opening and closing a window using remote operations. However, there are refinements that still remain such as the complexity of the structure, the inviting of largesse of scale, difficulty of manufacture, and problems with installation to windows etc. Further, there are the problems that compatibility with changes in the weather cannot be achieved without sensors such as rainwater sensors etc., and deficiencies with consideration to crime prevention when a key opening and closing mechanism is not provided.

In document 2, it is possible to automatically open a window, but the details of a structure for this are not disclosed, the invention cannot be specified, results for the configuration of the invention are not sufficiently provided, so that problems remain in understanding the invention.

In document 3, the configuration is such that the locking rod is operated by motor control means. This results in problems such as the structure becoming complex and inviting rises in cost, etc. Further, this invention is confined to an opening and closing mechanism for the double-sliding doors. There are therefore problems such as an inability to provide compatibility with changes in the weather without providing sensors such as rainwater sensors and deficiencies with regards to giving consideration to crime prevention without providing a key opening and closing mechanism.

In document 4, the invention is confined to windows etc. capable of being opened and closed automatically using various sensors and remote-controlled switches. There is therefore a problem with regards to there being no provisions relating to the occurrence of crimes such as theft and burglary, etc. and as such this is confined to one-dimensional improvements.

In order to resolve the above, [1] the present invention provides an automatic opening and closing system for a window for opening and closing a window using automatic locking and/or unlocking of a lock section of a win dow and using a sensor such as a rainwater sensor etc., so as to achieve comprehensive automatic locking and unlocking at the same time as achieving automatic opening and closing. This is capable of being fitted in a straightforward and reliable manner to existing windows, is of a simple construction requiring few parts, and can be fitted to windows (bay windows etc.) of western style houses. Further, [2] by using the automatic locking and/or unlocking of the lock section and sensors such as rainwater sensors etc., in situations where people are outside, people are sleeping, children are left alone in the house, or infants are in the house etc., it is possible to automatically over (close) the windows even if windows are left open. (With the converse operation) it is also possible to take into consideration providing compatibility with sudden changes in the weather, contribute to improvements regarding crime prevention, and enable people to go outside with peace of mind. Further, [3] it is also intended to provide window locking and/or un locking means that are easy on the physically disabled or children etc.

In the aspect of the invention of claim 1, there is provided an automatic opening and closing system for opening and closing a window by automatically locking and/or unlocking a lock section of the window and by using a sensor, with a lock locking and unlocking mechanism for locking and/or unlocking a window of a building comprising a stand fitted into a hole opened in one window frame, a lock section constituted by a lock body provided at this stand, a lock piece engaging with the lock section provided at the remaining frame, and a first controller for moving the lock piece, with the lock locking and unlocking mechanism actuated by operation of the first controller so as to lock and unlock the window.

Here, a window opening and closing mechanism for opening and/or closing the window is comprised of a drive section provided at one window, a main drive section provided at a window frame, a drive section for driving the main drive section, stopping means for stopping the drive section, and a second controller actuating the drive section, provided so as to open and close the window as a result of operating the second controller so as to actuate the drive section and main drive section.

Claim 1 is a configuration for locking and/or unlocking, and opening and closing a window using the lock locking/unlocking mechanism and the first controller and/or the window opening and closing mechanism and the second controller, to as to achieve the advantages “1” to “3” described above. It is therefore possible to achieve this purpose with a simple device of a driven section provided at one window and a drive main drive section provided at a window, and this principle is convenient for straightforward installation at existing windows.

In the aspect of the invention of claim 2, there is provided an automatic opening and closing system for opening and closing a window by automatically locking and/or unlocking a lock section of the window and by using a sensor, with a lock locking and unlocking mechanism for locking and/or unlocking a window of a building comprising a stand fitted into a hole opened in one window frame, a lock section constituted by a lock body provided at this stand, a lock piece engaging with the lock section provided at the remaining from, and a first controller for moving the lock piece, with the lock locking and unlocking mechanism actuated by operation of the first controller so as to lock and unlock the window.

Here, the window opening and closing mechanism for opening and/or closing the window comprising a fitting lug body fitted to the frame, a stopping lug provided at the fitting lug body, a drive section such as a motor etc. capable of for ward and reverse motion provided at the fitting lug body, a transmission mechanism provided at the drive section, a drive section body driven by the transmission mechanism and coming into contact with the window frame, and a second controller for actuating the drive section, with the drive section being actuated by operation of the second controller so as to open and close the window.

Therefore, in claim 2, there is provided a configuration for locking and/or unlocking, and opening and closing a window using the lock locking/unlocking mechanism and the first controller and/or the window opening and closing mechanism and the second controller, to as to achieve the advantages “1” to “3” described above. It is therefore possible to achieve this purpose with a simple device of a drive section body axially fitted to the drive section, and this principle is convenient for straightforward installation at existing windows.

In the aspect of the invention of claim 3, there is provided an automatic opening and closing system for opening and closing a window by automatically locking and/or unlocking a lock section of the window and by using a sensor, with a lock locking and unlocking mechanism for locking and/or unlocking a window of a building comprising a stand fitted into a hole opened in one window frame, a lock section constituted by a lock body provided at this stand, a lock piece engaging with the lock section provided at the remaining frame, and a first controller for moving the lock piece, with the lock locking and unlocking mechanism actuated by operation of the first controller so as to lock and unlock the window.

Further, the window opening and closing mechanism for opening and/or closing the window is comprised of a fitting lug body equipped with a pair of projection sections fitted at the frame, a stopping lug provided at the fitting lug body, a drive section of a motor etc. provided at the fitting lug body capable of rotating forwards and in reverse,

a transmission mechanism provided at this drive section, a drive section body driven by the transmission mechanism and coming into contact with the window frame, and a second controller actuating the drive section, wherein the fitting lug body is fixed to the window frame by inserting one projection section of the fitting lug body in to a gap formed between the frame and the window frame and fastening a stopping lug provided at the other projection section to the frame, and the drive section is actuated by operation of the second controller so that a window is opened and closed.

Therefore, in claim 3, there is provided a configuration for locking and/or unlocking, and opening and closing a window using the lock locking/unlocking mechanism and the first controller and/or the window opening and closing mechanism and the second controller, to as to achieve the advantages “1” to “3” described above. It is therefore possible to achieve this purpose with a simple device of a drive section body axially fitted to the drive section, and this principle is convenient for straightforward installation at existing windows.

In an aspect of the invention of claim 4, there is provided an automatic opening and closing system for opening and closing a window by automatically locking and/or unlocking a lock section of the win dow and by using a sensor, wherein the window opening and closing mechanism as disclosed in any one of claim 1 to claim 3 is a configuration functioning as a rainwater sensor arranged outside of a room, a temperature sensor or a wind sensor in a room, or a controller operated by remote operation etc., with a drive section constituting the window opening and closing mechanism being actuated under the command of the control section, so that the window is opened and closed.

Claim 4 therefore achieves the advantage of claims 1 to 3, and is capable of providing an optimum second controller for achieving this advantage.

The aspect of the invention of claim 5 is an automatic opening and closing system for opening and closing a window by automatically locking and/or unlocking a lock section of the window and by using a sensor. Here, the lock locking and unlocking mechanism disclosed in any one of claim 1 to claim 3 is configured so as to be controlled by a lock sensor provided at the window glass, or by automatic means such as remote operation, with the lock piece being actuated via this controller.

Claim 5 therefore achieves the advantage of claims 1 to 3, and is capable of providing an optimum lock locking and unlocking mechanism for achieving this advantage.

The aspect of the invention of claim 6 is an automatic opening and closing system for opening and closing a window by automatically locking and/or unlocking a lock section of the window and by using a sensor. Here, a vibration sensor is provided for the window disclosed in any one of clam 1 to claim 3, with alarm means being actuated by the operation of this vibration sensor.

Claim 6 therefore achieves the advantage of claims 1 to 3, and is capable of providing a further vibration sensor provided at the window in order to achieve a further advantage.

An aspect of the invention in claim 7 is an automatic opening and closing system for opening and closing a window by automatically locking and/or unlocking a lock section of the window and by using a sensor. Here, the window opening and closing mechanism disclosed in claim 1 comprises a motor capable of rotating forwards and backwards, a resilient body with a motor pulley wrapped around, a first gear with the resilient body wrapped around, a second gear meshing with the first gear, a third gear meshing with the second gear, and a ratchet with a spring stopped at the third gear, wherein, after the window is opened to a fixed position, the third gear is restricted by the ratchet so as to stop the window in a fixed position, and restriction of the ratchet and the third gear is released by a sensor such as the rainwater sensor or temperature sensor etc. so as to enable the window to be moved in a closing direction by reaction force of the spring.

Claim 7 therefore achieves the advantage of claim 1 and provides an optimum opening and closing mechanism for achieving this advantage. Further, there is the benefit of providing a window opening and closing gig capable of being installed at an existing window and/or frame.

An aspect of the invention of claim 8 is such that an automatic opening and closing system for a window for opening and closing a win dow using automatic locking and/or unlocking of a lock section of a window and a sensor. Here, the window opening and closing is now disclosed in claim 1 is comprised of a motor capable of forward and reverse rotation, an extending and retracting rod linked to this motor capable of extending and retracting due to rotation of the motor, and a window fitting section at the extending and retracting rod, wherein, after the window is opened to a fixed position, rotation of the motor is stopped, the window is stopped at a fixed position, and it is possible to move the window in a closing direction by extension and retraction of the rod using sensors such as the rainwter sensor and temperature sensor, etc.

Claim 8 therefore achieves the advantage of claim 1 and provides an optimum opening and closing mechanism for achieving this advantage. Further, there is the benefit of providing a window opening and closing mechanism that is simple in structure and operates in a reliable manner.

In an aspect of the invention of claim 9, there is provided an automatic opening and closing system for a window for opening and closing a win dow using automatic locking and/or unlocking of a lock section of a window and a sensor. Here, the window opening and closing mechanism disclosed in claim 1 is comprised of a motor capable of forward and reverse rotation, a pinion capable of forward and reverse rotation by the motor, and a rack provided at the window meshing with the pinion, wherein after opening of the window to a fixed position using positive rotation of the pinion, rotation of the motor is stopped so that the window is stopped at a fixed position, and the window can be move in a closing direction through reverse rotation of the pinion due to rotation of the rotor using a sensor such as the rainwater sensor, or temperature sensor etc.

Claim 9 therefore achieves the advantage of claim 1 and provides an optimum opening and closing mechanism for achieving this advantage. Further, there is the benefit of providing a window opening and closing mechanism capable of being installed so as to match the window.

In an aspect of the invention of claim 10, an automatic opening and closing system for a window for opening and closing a window using automatic locking and/or unlocking of a lock section of a window and a sensor. Here, the window opening and closing mechanism disclosed in claim 1 is comprised of a motor capable of forward and reverse rotation, a screw shaft linked to the motor, a support section screwed together with the screw shaft, and a window fitting section arranged at the support section, vein, after the window is opened to a fixed position using forward rotation of the screw shaft through rotation of the motor, and after rotation of the motor is stopped to that the window is stopped at a fixed position, the window can be moved in a closing direction using reverse rotation of the screw shaft due to rotation of the motor using sensors such as the rainwater sensor and temperature sensor etc.

Claim 10 therefore achieves the advantage of claim 1 and provides an optimum opening and closing mechanism for achieving this advantage. Further, there is the benefit of providing a window opening and closing mechanism capable of reliably opening and closing the window.

In an aspect of the invention of claim 11, there is provided an automatic opening and closing system for a window for opening and closing a window using automatic locking and/or unlocking of a lock section of a win dow and a sensor. Here, the window opening and closing mechanism disclosed in claim 1 is comprised of a motor capable of forward and reverse rotation, a pulley linked to the motor, a belt wrapped around the rollers, another pulley around which the belt wraps and a window fitting section provided at the belt, wherein, after the window is opened to a fixed position using forward rotation of the belt through rotation of the motor, and after rotation of the motor is stopped to that the window is stopped at a fixed position, the window can be moved in a closing direction using reverse rotation of the be it due to rotation of the motor using sensors such as the rainwater sensor and temperature sensor etc.

Claim 11 therefore achieves the advantage of claim 1 and provides an optimum opening and closing mechanism for achieving this advantage. Further, there is the benefit of providing a window opening and closing mechanism capable of quietly opening and closing the window.

In an aspect of the invention of claim 12, there is provided an automatic opening and closing system for a window for opening and closing a window using automatic locking and/or unlocking of a lock section of a window and a sensor, rein the window opening and closing mechanism disclosed in claim 1 is comprised of a first magnet on one side, a second magnet on another side, and an for NS polarity switching supplying and ceasing supply of electricity to the first magnet, wherein after electricity is supplied to the first magnet so that the window is opened to a fixed position, when an instruction is given to the window opening and closing mechanism using a sensor such as the rainwater sensor and temperature sensor etc., and the supply of electricity to the first magnet is stopped, the window can be moved in a closing direction.

Claim 12 therefore achieves the advantage of claim 1 and provides an optimum opening and closing mechanism for achieving this advantage. Further, there is the benefit of providing a window opening and closing mechanism capable of quietly and reliably opening and closing the window.

In an aspect of the invention of claim 13, there is provided an automatic opening and closing system for a window for opening and closing a window using automatic locking and/or unlocking of a lock section of a window and a sensor, wherein the drive section body disclosed in claim 2 and claim 3 is means capable of being connected to and distanced from the window frame.

Claim 13 is therefore capable of achieving the advantage of claim 2 and claim 3, and is capable of providing an optimum window opening and closing mechanism for achieving this advantage. This also has the advantage that the window can be opened manually and that the window can then be opened manually at the time of damage to the window opening and closing mechanism or when power does not function.

### BRIEF DESCRIPTION OF THE DRAWINGS

FIG. 1 is a front view of a lock locking/unlocking of the present invention.

FIG. 2-1 is a cross-sectional view of a lock locking/unlocking mechanism of the present invention.

FIG. 2-2 is a cross-sectional view with the cover fitted to FIG. 2-1.

FIG. 3-1 is a front view a first controller of a lock locking/unlocking mechanism of the present invention.

FIG. 3-2 is a front view of both a first controller for the lock locking and unlocking mechanism and a second controller for the window opening and closing mechanism of the present invention.

FIG. 3-2 is a front view of a further example of use of both a first controller for the lock locking and unlocking mechanism and a second controller for the window opening and closing mechanism of the present invention.

FIG. 3-4 is a front view a second controller of a lock opening and closing mechanism of the present invention.

FIG. 4 is a schematic view showing a first embodiment of the present invention.

FIG. 5 is a schematic view showing a second embodiment of the present invention.

FIG. 6 is a schematic view showing a third embodiment of the present invention.

FIG. 7 is a schematic view showing a fourth embodiment of the present invention.

FIG. 8 is a schematic view showing a fifth embodiment of the present invention.

FIG. 9 is a schematic view showing a sixth embodiment of the present invention.

FIG. 10 is a schematic view showing an example of actual use of the present invention.

FIG. 11 is a schematic view showing a further example of actual use of the present invention.

FIG. 12 is a schematic view showing another example of actual use of the present invention.

FIG. 13 is a schematic view showing a still further example of actual use of the present invention.

FIG. 14 is a circuit diagram showing an example of a circuit of the present invention.

FIG. 15-1 is a schematic side view showing the essential parts of a seventh fit of the present invention.

FIG. 15-2 is a schematic cross-section along A-A of FIG. 15-1.

FIG. 15-3 is a schematic cross-section along B-B of FIG. 15-1.

FIG. 15-4 is a schematic plan view illustrating the relationship between a fitting lug body and rotating shaft shown in FIG. 15-1.

FIG. 16 is a schematic side view showing the essential parts of an eighth embodiment of the present invention.

FIG. 17-1 is a schematic side view showing the essential parts of a ninth embodiment of the present invention.

FIG. 17-2 is a side view of FIG. 17-1.

FIG. 18 is a schematic view arranged with a rain water sensor of the pre sent invention on a opening of an example of the related art.

### DESCRIPTION OF THE EMBODIMENTS

Each of the embodiments of the pre sent invention are now described with reference to the drawings.

[1] First, a description is given of the relationship between a lock locking/unlocking mechanism of an automatic lock locking/unlocking apparatus according to the present invention and a lock section 2. The lock locking/unlocking mechanism 1 is a structure for locking/unlocking the lock section 2 and in this example, the lock section 2 is comprised of a base 4 provided to utilize holes of the related art established at a window frame 3, a lock body 5 provided so as to freely go up and down via a guide mechanism such as a dovetail insertion etc. at the base 4, a drive section (not shown) built-into the base 4 for moving the lock body 5, and a lock piece 6 provided at another window frame 3-1. This lock body 5 causes a lock pawl 500 of the lock body 5 to move as a result of being moved (moved in a vertical direction) by the lock locking/unlocking mechanism 1. As a result of movement of the lock pawl 500, engagement and disengagement takes place with the lock piece 6, so that locking and unlocking of the lock section 2 is achieved. It is taken that the lock locking/unlocking mechanism 1 is operated remotely but the lock locking/unlocking mechanism 1 may also be operated manually. It is also possible to provide a vibration sensor 7 (alert sensor) at the lock locking/unlocking mechanism 1 and/or the glass 3a etc. For example, this vibration sensor 7 may be provided independently or in common at locations at any of the lock body 5 and/or the window frame 3 and glass 3a etc. Utilization may then be such that an alert is then issued at the stage were an alert is generated as a result of vibrations to the lock body 5 etc. or accidents such as damage etc., with notification of an abnormality then being given at a prescribed location etc. so as to prevent crime, or utilization in forgetting to lock etc. may also be considered. Further, the lock locking/unlocking mechanism 1 is covered by a cover 8 so as to provide protection from abnormal situations such as the window from 3 or glass 3a being damaged.

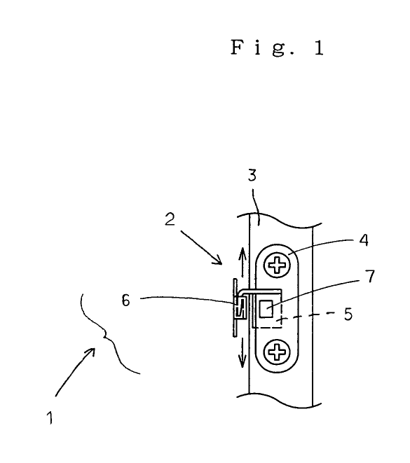

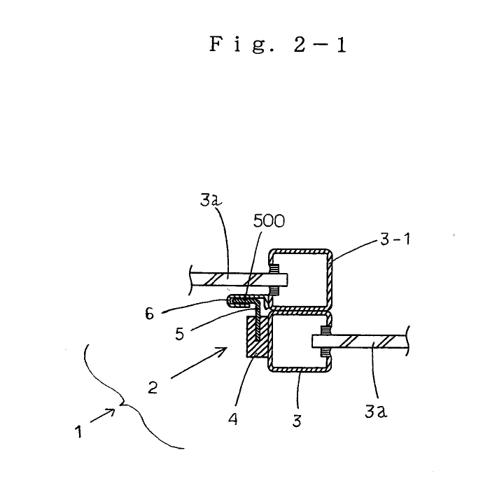

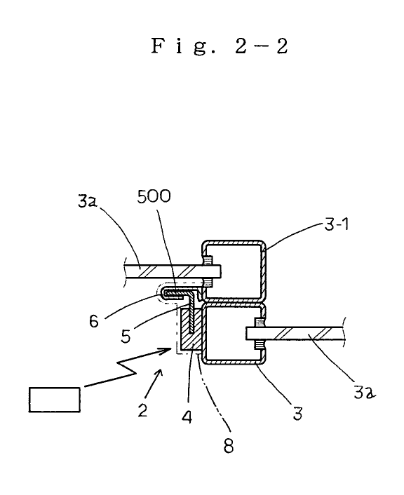

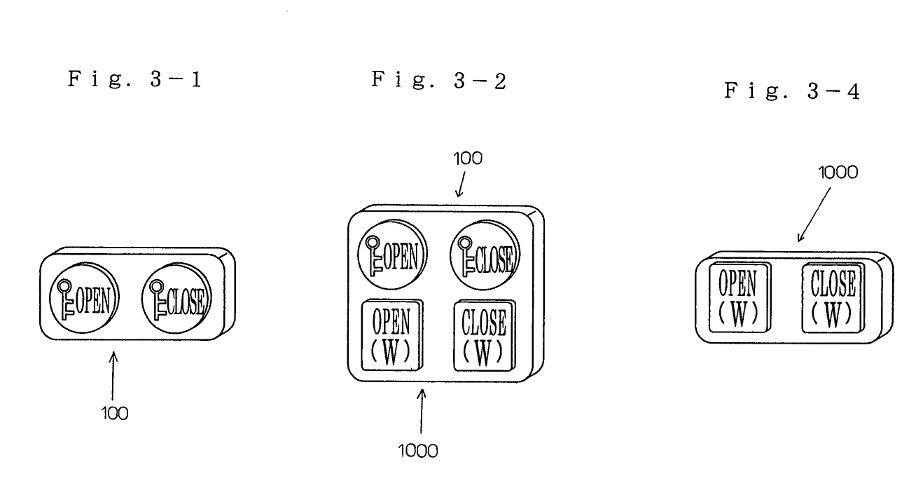

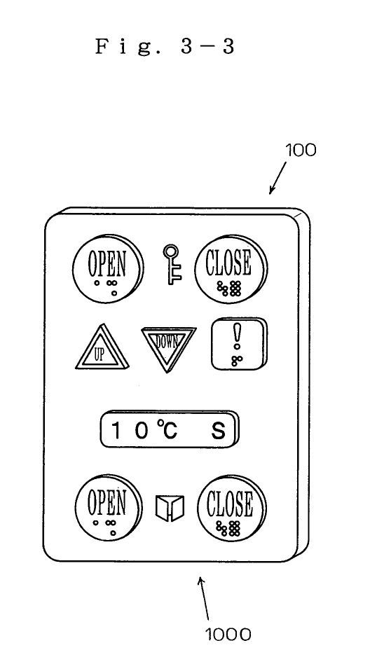

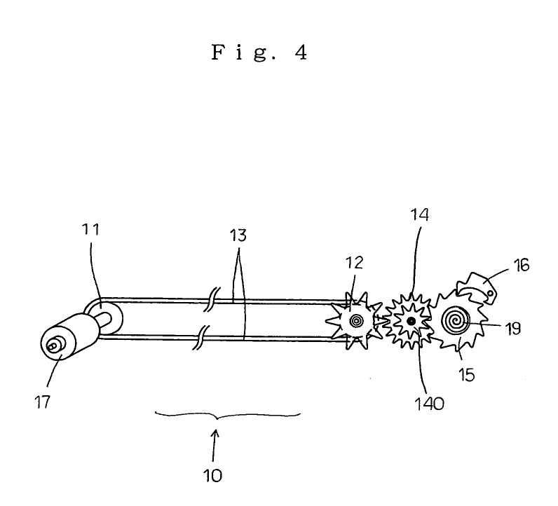

This lock locking/unlocking mechanism 1 is now described individually for each example shown in FIG. 3-1 to FIG. 3-4. First, FIG. 3-1 ensures a simple structure and straightforward operation and prevents erroneous operation, with a first controller 100 adopting a structure with two buttons for opening and closing. FIG. 3-2 is an example of a multifunction structure and is a structure where detachment of the lock locking/unlocking mechanism 1 and/or the window opening/closing mechanism 10 is completely automated. This is intended to bring about operation that is straightforward and automatic, and where operation may be performed without error by people who are weak or for whom comprehension is difficult such as the elderly, disabled, people suffering from dementia, or children etc. In this example, a second controller 1000 adopting a two button structure as buttons for opening and closing the window opening/closing mechanism 10 is used together at the first controller 100 of the lock locking/unlocking mechanism 1. In each example, the two button structure of buttons for opening and closing is a structure for providing identification using characters, raised characters or a color such as, for example, blue, for indicating an open state or identifying a closed state using characters, raised characters, or a color such as, for example, red, or a structure that is a modification of the structure shown in the drawings, etc. FIG. 3-3 is a structure where, for example, further multifunctionality is added to the embodiment shown in FIG. 3-2, where displays such as a temperature and humidity display or a display indicating turning on and off of a switch is added with the intention of improving usability and convenience. Further, FIG. 3-4 is a strut ensuring a straight forward structure that provides ease of operation and avoids erroneous operation, where the second controller 1000 is given a structure with two opening and closing buttons.

[2] The relationship between the window opening and closing mechanism 10 (automatic window opening and closing apparatus) for opening and closing the window 9 and controlling a drive section and a second controller (sensor such as a rainwater sensor, temperature sensor, window sensor etc., hereinafter taken to be a rainwater sensor 18) is described for each of the embodiments.

[2-1] FIG. 4 is a first embodiment as disclosed in claim 7 and is a window opening and closing 10 using gears and a resilient body. This window opening and closing mechanism 10 is comprised of a pulley 11 (transmission means) provided at a frame 90 (abbreviated to a fixed body such as a building or fixing means etc. in the following), a resilient body 13 wrapped around the pulley 11 and wrapped around a first gear 12, a second gear 14 meshing with the first gear 12 and supported at the window 9, a third gear 140 axially supported at the second gear 14, a ratchet 15 equipped with a spring 19 meshing with the third gear 14, and a pawl 16 for preventing the ratchet 15 from going in reverse. Power from the pulley 11 is transmitted to the first gear 12 and the second gear 14 by the resilient body 13. The window 9 can then be opened and closed and stopped by forward and reverse molt of the first gear 12. Further, the ratchet 15 engages with the third gear 140 axially supported at the second gear 14, with stopping taking place using the roveable pawl 16 meshing at the ratchet 15 at the time of stopping of the second gear 14. Further, a motor 17 is a main drive section, and a pulley 11 is provided at an output shaft of the motor 17. With the example of the second controller 1000, braking of the motor 17 is carried out by means such as the rainwater sensor 18 for detecting rainwater, or by manual means such as remote operation or a timer. Therefore, when the rainwater sensor 18 detects rainwater, the motor 17 is driven, and the window 9 is closed as a result of movement of the driven section described above (by rotation of the second gear 14). The motor 17 is then driven with the temperature sensor in a state of detecting a room temperature or outside temperature etc. of more than a prescribed value and the widow 9 is opened or closed by movement of the driven section. Driving of the motor 17 opening and closing the window 9 is possible by driving and stopping employing automatic control such as remote operation and/or a timer etc. constituting an example of the second controller 1000. Reverse driving of the ratchet 15 then utilizes reaction force of the spring 19 when the pawl 16 is opened. The rainwater sensor 18 is a structure for detecting rainwater and is set to conduct when it is raining as a result of rainwater being detected by the rainwater sensor 18. The case for a wind sensor is also the same as described above.

Next, describing opening of the win dow 9, after detection by the rainwater sensor 18 (obtained by a timer or remote control operation etc. described later)→motor 17 (forward rotation) pulley 11→first gear 12→resilient body 13→second gear 14 and/or third gear 140→ratchet 15→winding up of the spring 19→engagement with a pawl 16 stopping the ratchet 15, the motor 17 is stopped. Further, describing closing of the window 9, upon release of engagement of the pawl 16 from the ratchet 15, then closing takes place as a result of the order of repulsion of the spring 19→ratchet 15→second gear 14 and/or third gear 140 (reverse rotation) resilient body 13→first gear 12→pulley 11 (idling)→motor 17 (reverse rotation or idling)→completion of repulsion of the spring 19 (loosened state)→and stopping by the pawl 16 for stopping ratchet 15. Opening of the window 9 is achieved using a timer, remote operation, or manually (to save power) but it is preferable to ensure that the motor 17 and pulley 11 are idling and engagement of the pawl 16 is released. Characteristics of the opening and closing of the window 9 and opening and closing position etc. and or the method for opening and closing etc. will be described later.

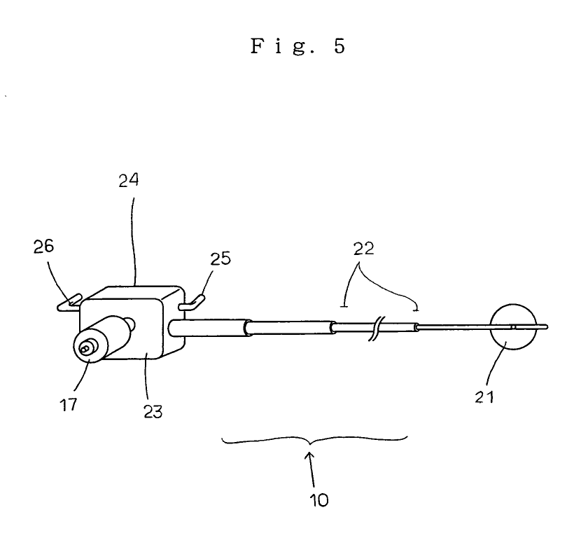

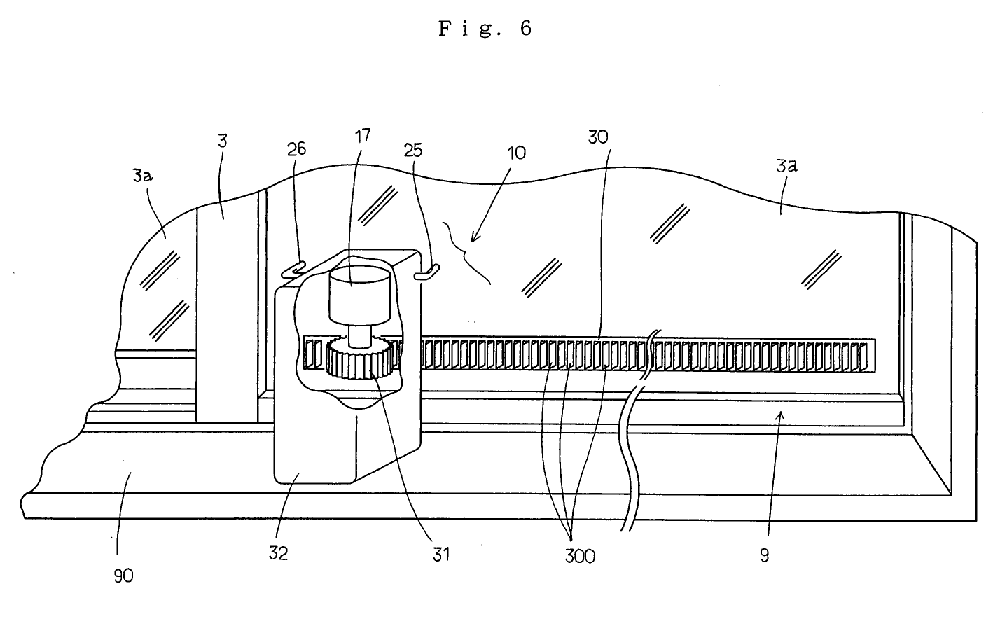

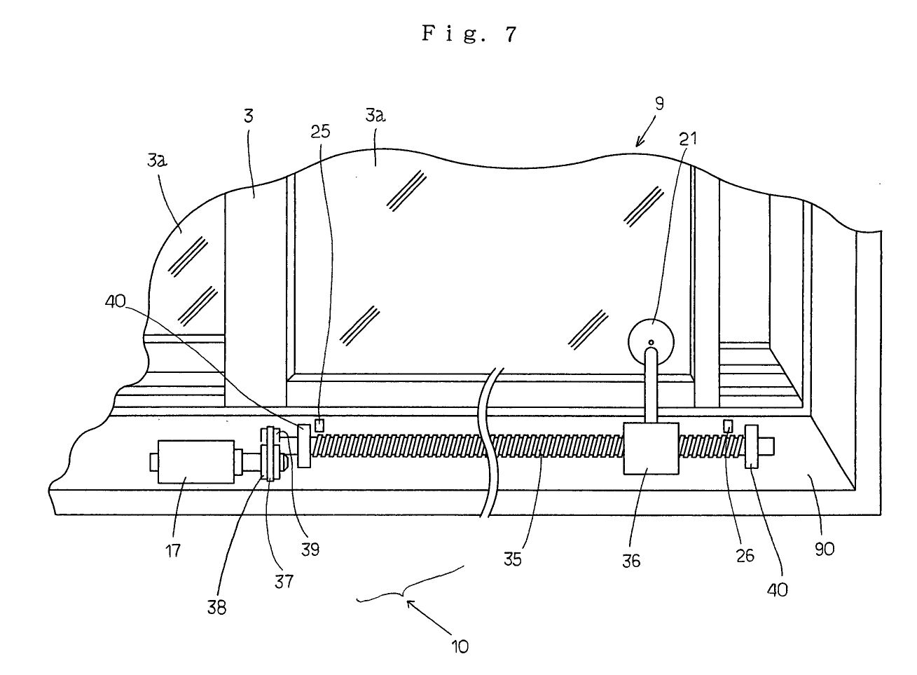

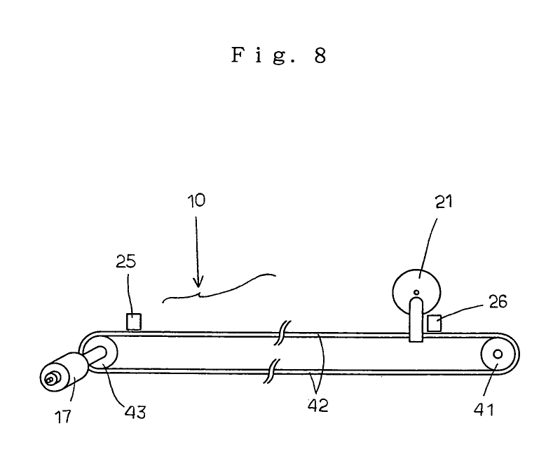

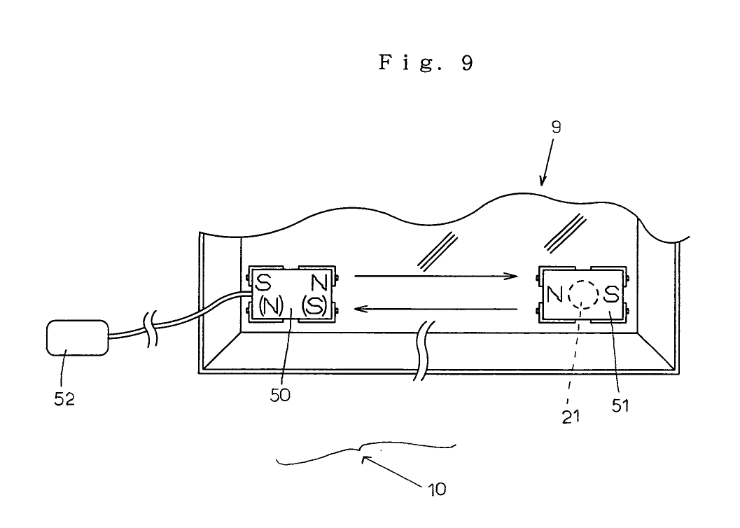

Further, with methods using timer settings or remote operation etc., what time the window 9 is opened (open) and what time the window is closed (close) etc. is set as settings for opening and closing the window 9. For example, a method where the window 9 is opened at 7 in the morning and closed at 5 in the afternoon is possible. Further, it is also possible to perform settings deciding the opening and closing speed of the window 9 and changing the opening and closing speed according to the type of window 9. For example, in the case of a window 9 that comes away from the window frame 3 easily, it is possible to make the speed of opening and closing slow and prevent the window 9 from coming away. Further, it is also necessary to take precautions regarding the automatic opening and closing speed when the window 9 is in a location where it is easy to make contact with a person's hand and it is also possible to avoid danger by changing the opening and closing speed. It is also possible to set the opening and closing speed by adjusting the rotational speed of the motor 17, adjusting the reaction force of the spring 19, and adjusting the reaction force of the magnet in other embodiments described later. Setting of the open and closed position of the window 9 can be completely open, half open, or the open width of the window 9 may be freely set. For example, on a hot day in the summer the window may be completely open, or on a cold day in winter the window may be slightly open. Further, the method of ventilation and time etc. may be freely set, and may conveniently be made to correspond to various intentions. Further, it is possible to set the speed of opening and closing as described above as a method for setting the opening and closing position. For example, this may take 30 seconds of rotation of the motor 17 at a rotational speed of 30 times per second and may take 20 second of rotation of the motor 17 at a rotational speed of 50 times per second. As a result, the opening and closing position can be decided for a fixed distance. Further, it is also possible to set the opening position in such a manner as to be stopped at a position 30 cm from the window frame 3 and 50 cm from the window frame 3, etc.

[2-2] FIG. 5 is the second embodiment as disclosed in claim 8 and is a window opening and closing mechanism 10 using an extending and retracting rod. This window opening and closing mechanisms 10 is comprised of a window attaching section 21 (window frame or glass 3a is also possible. For example, suckers are preferable), a nested extending and retracting rod 22 provided at a frame 90 linked at the window attaching section 21, a housing case 23 housing the extending and retracting rod 22, and a stand 24 for fitting the ho using case 23 to the window. In this example, the motor 17 constituting the main driving section is driven forwards and in reverse by operating the rainwater sensor 18 etc., the extending and retracting rod 22 is extended and contracted as a result of the forward and reverse movement of the motor 17, and the window 9 is opened and closed utilizing advancement and retraction of the window fitting section 21. The extending and retracting rod 22 is fitted in the housing case 23. Further, it is also possible to stop the window 9 at opening and closing ends or at prescribed positions by providing stopping means such as stoppers 25, 26 deciding the positions of open ends and closed ends of the window 9 etc. at the housing case 23 (other exam pies are the same). In this example, a structure is provided where stopping is achieved at the open end of the window 9 using a stopper 25 and similarly achieved at the closed end using a stopper 26 while at the same time stopping rotation of the motor 17. This means that it is possible to ensure safety and ensure the reliability of opening and closing the window 9. Other aspects of the configuration and/or operation are given in the example described above.

[2-3] FIG. 6 is a third embodiment as disclosed in claim 9, and is a window opening and closing mechanism 10 using a rack. This window opening and closing mechanism 10 is comprised of a rack 30 made of metal or resin etc. affixed to the window 9 constituting the drive slave section for opening and closing with window 9, a pinion 31 provided at a frame 90 engaging with the rack 30, a support case 32 provided at the frame 90 capable of supporting the pinion 31, and stopping means such as the stoppers 25 and 26. In this example, a motor 17 constituting the main drive section operated using a rainwater sensor 18 etc. is driven forward s and in reverse, and a (fixed side) pinion 31 provided at the frame 90 is driven forwards and in reverse via the forward and reverse movement of the motor 17. Then, in this example, the pinion 31 is fixed, the rack 30 meshing with this pinion 31 is moved in an opening and closing direction (with respect to a building and/or the frame 90), and the window 9 is opened and closed by the movement of this rack 30. In this example, the configuration is such that the rack 30 is affixed to the glass 3a and can easily be set and reset, is cheap, and can easily be affixed by somebody with no experience of such tasks. Further, in this example, the pinion 31 is mounted vertically at an output shaft of the motor 17 provided at the support case 32 and teeth 300 (provided in an erected manner facing the inside of the roan) of the rack 30 affixed to the glass 3a mesh at the pinion 31. This contributes to ease of fitting and straightforwardness of maintenance management. Further, fitting of the pinion 31 and rack 30 are examples of fitting members etc. Further, other aspects of the configuration and/or operation etc. are the same as the example described previously. In this example, reliable opening and closing of the driven section etc. and quite driving and/or quiet opening and closing of the window 9 is possible.

[2-4] FIG. 7 is the fourth embodiment disclosed in claim 10, and is a window opening and closing mechanism 10 using a support section equipped with a screw shaft and a screw. This window opening and closing mechanism 10 is carried of a window fitting section 21, made of resin or metal etc. affixed to the window 9 constituting the driven section for opening and closing the window 9, a screw shaft 35 provided at the frame 90 meshing with a screw (not shown) of the support section 36, a pulley 39 provided at one end of the screw shaft 35, a pulley 38 fixed to the pulley 39 and an output shaft of the motor 17 provided at the frame 90, a belt 37 installed by wrapping around the pulleys 39, 38, and the stopping means. In this example, the motor 17 constituting the main drive section operated by the rainwater sensor 18 etc. is driven forwards and in reverse, pulley 39 wrapped with the belt 37 from the pulley 38 rotates via the forward and reverse movement of this motor 17, and the screw shaft 35 is rotated backwards and forwards by the rotation of this pulley 39. The support section 36 then advances and retracts (left and right directions in the drawing) due to the forward and reverse movement of the screw shaft 35, and the window fitting section 21 also moves in the same way in accompaniment with this advancement and retraction so that the window 9 is opened and closed. In this example, stoppers 25, 26 are provided at the frame 90 and control takes place in the same manner as for the example described above. Other aspects of the configuration and/or operation are the same as for the examples described above. In the drawings, a shaft bearing is shown using numeral 40. In this example, the window 9 is reliably opened and close, the driven section is driven in a quiet manner and/or the window 9 is opened and closed in a quiet manner.

[2-5] FIG. 8 is a fifth embodiment as disclosed in claim 11 and is a window opening and closing mechanism 10 employing a support section etc. equipped with a pulley (propagation means such as a roller) and belt. The window opening and closing mechanism 10 is equipped with window fitting means made of resin or metal etc. applied to the window 9 constituting the driven section for opening and closing the window 9, a pulley 41 provided at the frame 90 coupled to the window fitting section 21, a belt 42 wrapped around the pulley 41, a pulley 43 this belt 42 is suspended from, and the stopping means described above. In this example, the motor 17 constituting the main driving section driven through operation of the rainwater sensor 18 etc. is drive forward and in reverse, with the pulley 43 and the pulley 41 with the belt 42 hung from the pulley 43 rotating as a result of forward and reverse rotation of the motor 17. The belt 42 is then made to ad vance and recede (move in opening and closing directions) as a result of the forward and reverse movement of the pulley 43 and the pulley 41. The window fitting section 21 coupled to the belt 42 then advances and retreats, and the window opens and closes in accompaniment with the advancing and retreating of the window fitting section 21. In this example, stoppers 25, 26 are provided at the frame 90 and control takes place in the same manner as for the example described above. Further aspects of the configuration and/or operation are the same as for the example described previously. In this example, the window 9 is reliably opened and close, the driven section is driven in a quiet manner and/or the window 9 is opened and closed in a quiet manner.

[2-6] FIG. 9 is a sixth embodiment disclosed in claim 12 and is a window opening and closing mechanism 10 using a magnet and supply etc. This opening and closing mechanism 10 is comprised of an electromagnet 50 affixed to the window 9 constituting a driven section for opening and closing the window 9 (first magnet for one side), the window fitting section provided at the window 9, another magnet 51 coupled to the window fitting section 21 (second magnet of the other side), and a mechanism 52 used for switching polarity between N and S through excitation of the electromagnet 50. In this example, through operation of the rainwater sensor 18 etc. and/or the excitation and/or stopping excitation of the electromagnet 50 via the mechanism 52 for switching NS polarity and utilizing attraction or repulsion of the magnet 51, the window fitting section 21 is advanced and retracted, and the window 9 is opened and closed as a result. In this example, stoppers 25, 26 are provided at the frame 90, and stopping (stopping) at the open and closed ends is achieved as with the example described previously. Other aspects of the configuration and/or operation are the same as for the example described previously. In this example, the window 9 is reliably opened and close, the driven section is driven in a quiet manner and/or the window 9 is opened and closed in a quiet manner. In this example, it is possible to stop the window 9 at arbitrary positions through excitation of and stopping of excitation of the electromagnet 50. Moreover, in this example, there are cases where remote operation is not necessary as a result of utilizing a timer and excitation of and/or stopping of excitation of the electromagnet. It is also possible to close or open the win dow 9 via repulsion means (not shown) such as a spring together with interrupting and switching over the magnetism of the electromagnet 50 and the magnet 51.

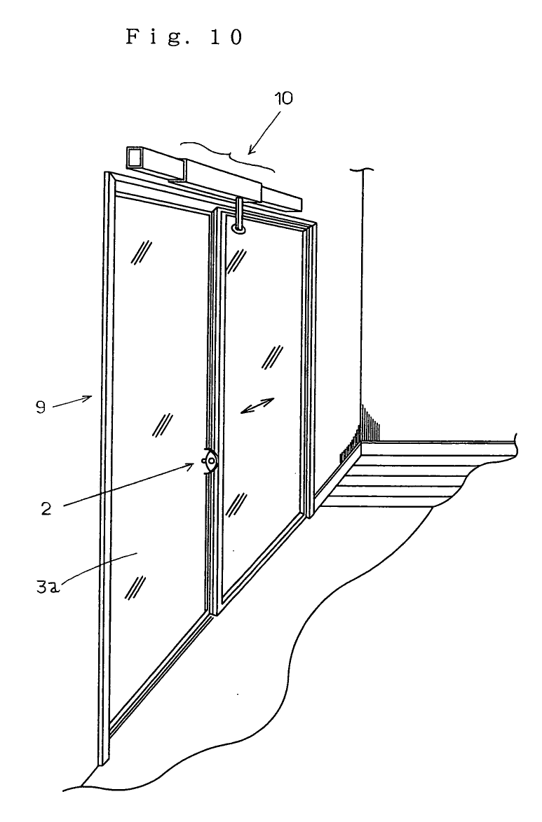

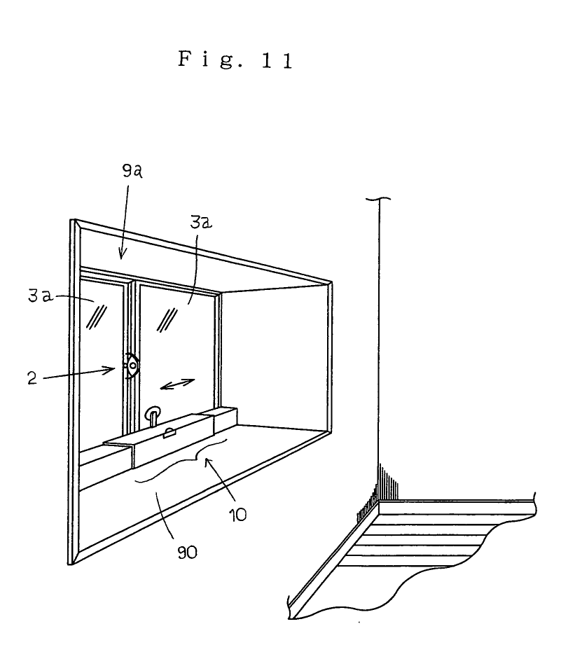

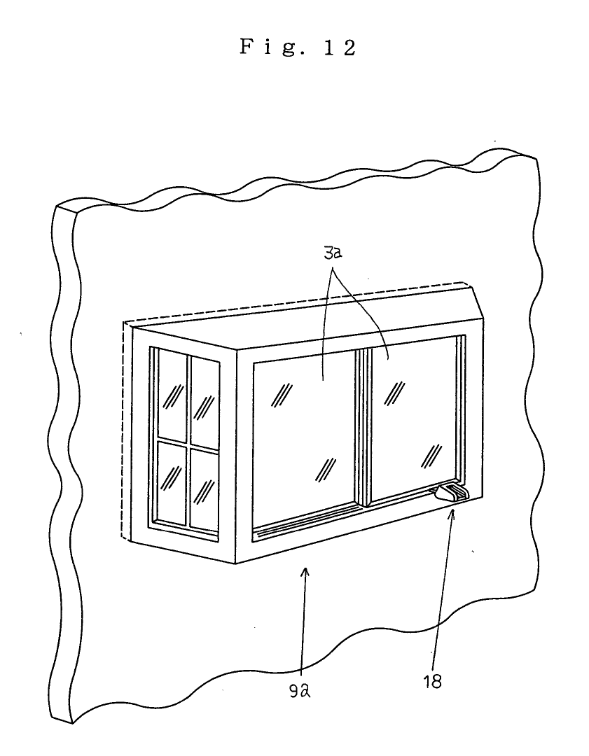

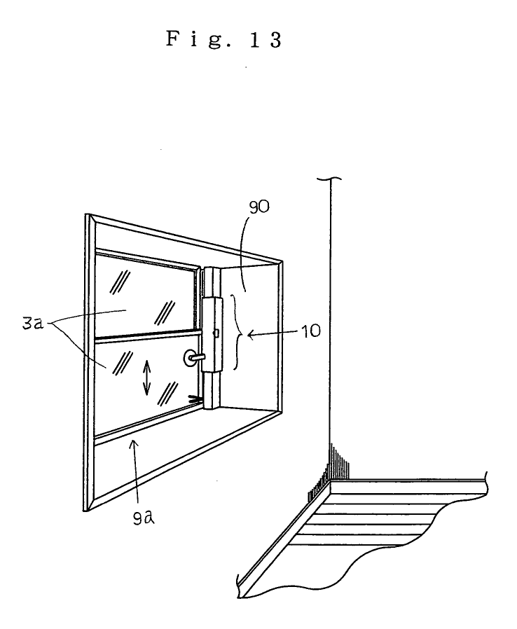

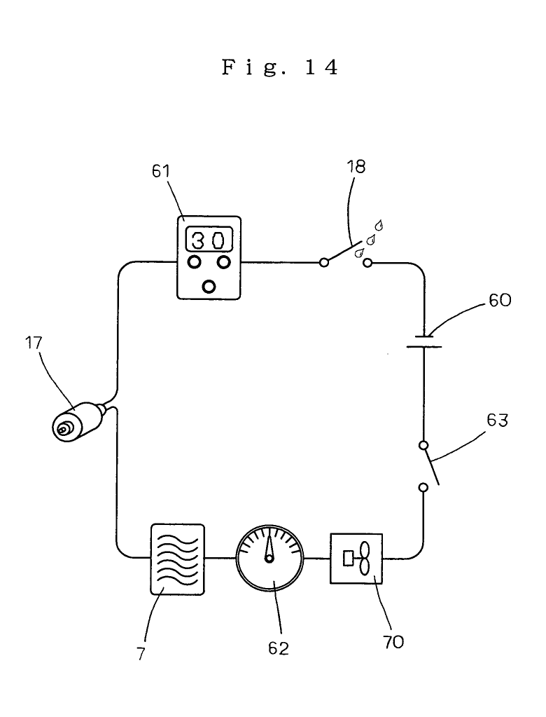

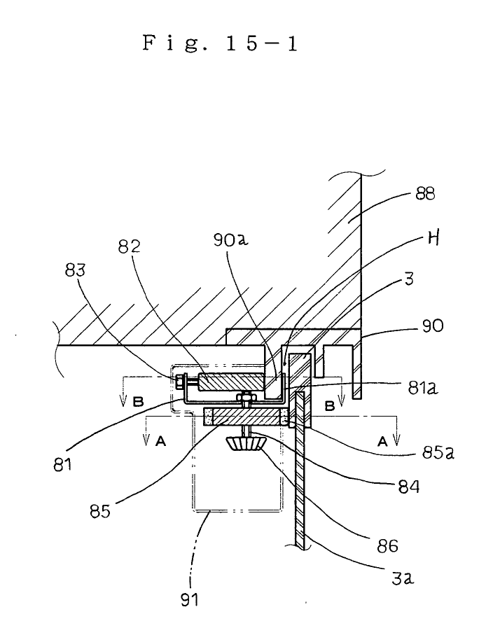

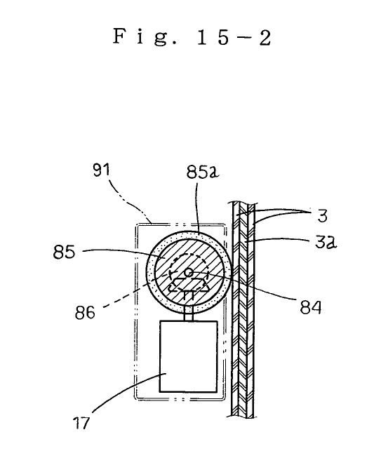

At the window 9 shown in FIG. 10, it is possible to ensure that there is no obstruction provided during movement from the window 9 to outside by positioning the window opening and closing mechanism 10 of the present invention at the frame 90. Straightforward fitting to the kind of bow window 9a common to western houses as shown in FIG. 11 to FIG. 13. In particular, in the case of bay window 9a, simple locating without obstruction is possible in where it is difficult to find space to that there is only a little space to work with. FIG. 12 is a view of a bay window 9a as viewed from outside, with detection of rainwater being carried out with the rainwater sensor 18 projecting to out side. Here, a rainwater sensor 18 is shown in each of the drawings but this is by no means limited to rainwater sensors 18, but it is also possible to install solar cells. In this case, the solar cells may be fitted at the same position or a different position, and a particular position is not specified.

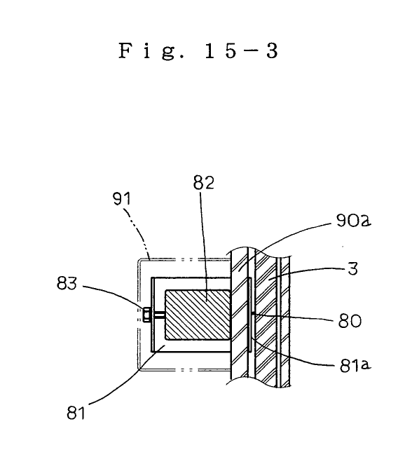

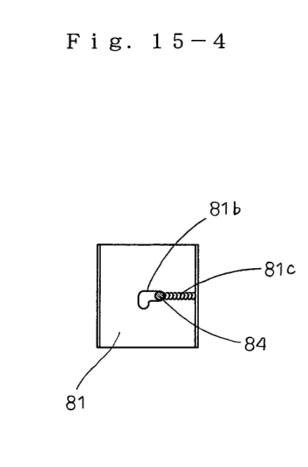

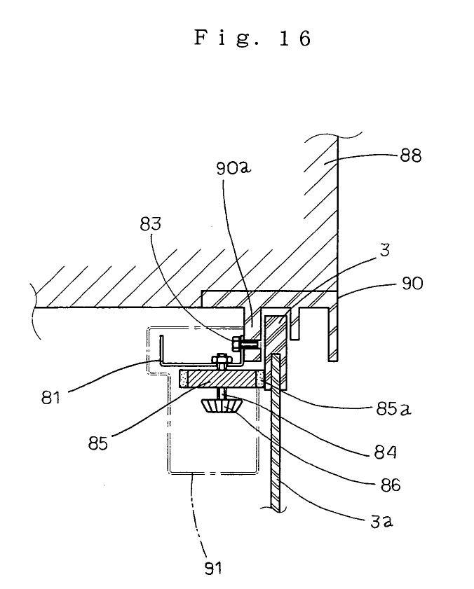

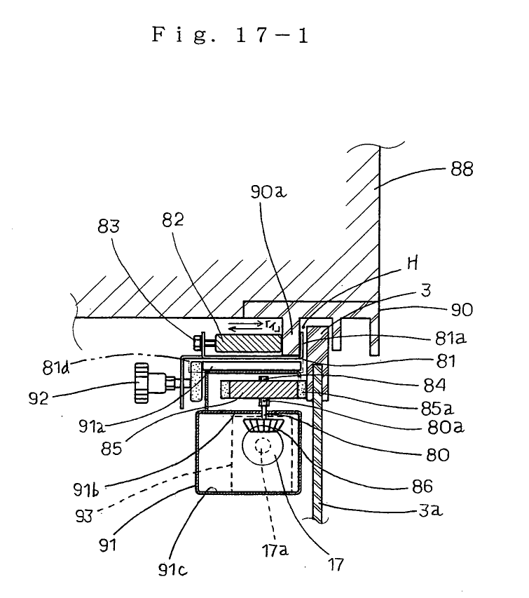

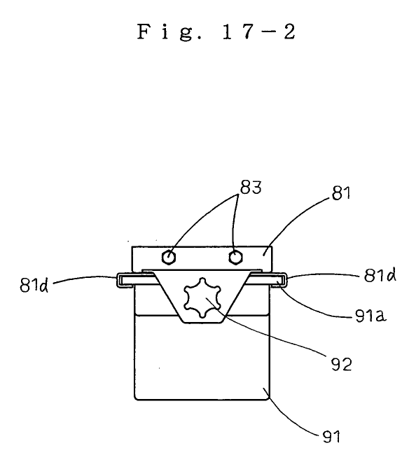

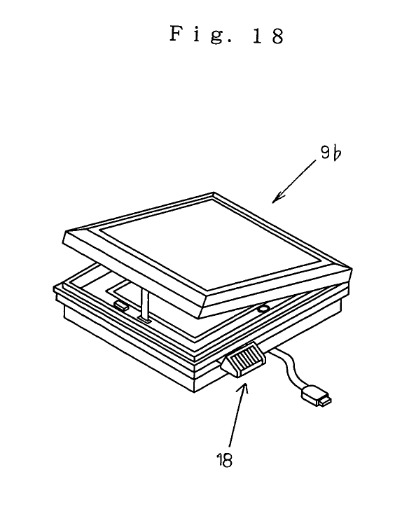

FIG. 14 is a schematic diagram of a circuit of the present invention, where numeral 60 indicates a battery, 61 indicates a timer, 62 indicates a temperature sensor or rain sensor 18, and 7 is a vibration sensor. Therefore, for example, a switch 63 is provided that energizes in the event that a set time is reached and the timer 61 operates, in the event that the temperature sensor 62 reaches a fixed temperature, in the event that the rainwater sensor 18 detects rainwater, or in the event of a remote operation, etc. FIG. 18 shows a rainwater sensor for a filing 9b of the related art. The present invention can of course be adopted for this ceiling 9b. In this case, the present invention can of course be adopted in opening and closing of a door of an exit or entrance, or gate etc., and independent or combined use of various sensors such as the rainwater sensor 18, vibration sensor 7, wind sensor 70, human sensors or remote sensors may also be appropriately selected as a sensor etc. taking into consideration security conditions, purpose of use, or opportunities etc. Usage where these remote operations etc. are combined is also possible. In the example of a wind sensor 70, it is possible to reliably open and close the window 9 at the time of strong wind, and abuse can be avoided.

[2-7] FIG. 15-1 to FIG. 15-3 show a seventh embodiment disclosed in claim 3 adopting a configuration where a fitting lug body 81 is fixed using a gap H formed between a projection 90a of the frame 90 and this projection 90a. In this example, after one projection 81a of the fit ting lug body 81 is inserted into the gap H, this is fixed to the window frame 3 using a bush 82 and a stopper lug 83 provided at the projection 81a. A rotating wheel 85 (drive section body) projecting from an opening in the cover described later is supported in a freely rotating manner at the fitting lug body 81 via a rotating axis 84 (transmission mechanism). An engagement section 85a (drive section body) of rubber, resin or bristles etc. is provided at this rotating wheel 85. This engaging section 85a comes into contact with the side surface of the window frame 3 and the engaging section 85a rotates so that the window 9 is moveable. The window 9 is then opened and closed by the movement of this win dow 9. A configuration is also preferable where forward and reverse rotation of the rotating wheel 85 is transmitted by a gear mechanism 86 (transmission mechanism such as a bevel gear, worm, or spur gear etc.) when the motor 17 rotates forward and in reverse. This may be a configuration adopting a transmission mechanism of an output shaft (not shown) of the mot or 17 or a transmission mechanism of a construction where coupling to the rotating shaft 84 takes place via a medium (not shown). Further, numeral 91 in the drawings is a cover enclosing the rotating shaft 84, gear mechanism 86 and/or the rotating wheel 85 etc. Opening of the window 9 in this example usually follows the process of detection by the rainwater sensor 18→motor 17 (forward rotation)→gear mechanism 86→rotating wheel 85→window 9 (moveable and open). Further, closing of the window 9 is constituted by an operation that is the reverse of the operation described above. In this example, an example using the stopping lug 83 is given where the bush 82 is omitted. Further, this is one example of rotation of a transmission mechanism. Further, it is also possible to attach sliding stopping means by providing unevenness and slits etc. in the engaging section 85a and/or the window frame 3 or providing unevenness in thee side surface of the window frame 3. By adopting a configuration for sliding stopping means such as slits etc., it is possible to make the window 9 moveable in a reliable manner. Further, FIG. 15-4 is an example of means for connecting and distancing the rotating wheel 85 and the window frame 3. Here, a dial (not shown) it utilized to move the rotating shaft 84, contact of the engaging section 85a and the side surface of the window frame 3 is released, and the window 9 is put into a free state. Along hole 81b having the dial and an engaging hole section and/or a spring 81c are then utilized to make it possible to move the rotating shaft 84 and the rotating wheel 85 etc. As a result, the use of the window 9 in a free state is possible, or it can be intended to ensure convenience at the time of damage of this device.

[2-8] FIG. 16 is an eighth embodiment disclosed in claim 2, with the fitting jig body 81 being fixed direly to the frame 90 or drive body 88 via a stopping lug 83, with the overall mechanism being the same as for the seventh embodiment.

[2-9] FIG. 17-1 and FIG. 17-2 are a ninth embodiment equipped with the connecting and distancing means disclosed in claim 13, with a pinching piece 81d provided on both sides of the fitting lug body 81, and a guard piece 91a of a cover 91 being inserted to this pinching piece 81d. A central shaft 80 is provided in an erect manner via a gear mechanism 86 at an output shaft 17a of the motor 17 from a gear case 93 provided at a bottom surface 91c of the cover 91. A rotating shaft 84 is then coupled in a hanging manner via insertion of the central shaft 80 and/or a stopping pin 80a and a rotating wheel 85 is fixed at the rotating shaft 84. Further, this rotating wheel 85 projects from the opening of the cover 91. The rotating wheel 85 provided at the rotating shaft 84 projects from the opening of the cover 91. In this example, the cover 91 and/or the rotating wheel 85 are made to move to the front and rear (in a direction from left to right, i.e. in the direction of arrow “b” in FIG. 17-1) via an adjustment jig 92 (means capable of connecting and distancing) provided at the fitting jig body 81. The adjustment jig 92 is then screwed in, the cover 91 and rotating wheel 85 advance, the rotating wheel 85 cares into contact with the window frame 3, and at the time of contact, the window 9 is moved by rotation of the motor 17. The cover 91 and/or the rotating wheel 85 are then retracted by unscrewing the adjustment jig 92, the rotating wheel 85 is distanced from the window frame 3, and the window 9 can be freely moved within this distance.

A feature of the present invention is that the automatic opening and closing system can be installed at an existing window 9, glass 3a, or casing 90. Therefore, by effectively utilizing the window 9, glass 3a and casing 90 and building etc. it is possible to reduce costs, eliminate the harm that accompanies waste, and protect the environment. Utilization is of course also possible with new windows 9, glass 3a, casing 90 or buildings etc. Further, utilization as a structure integrated with newly established windows 9, gloss 3a, casing 90 and buildings etc. is also possible.

1. An automatic opening and closing system for opening and closing a window by automatically locking and/or unlocking a lock section of the window and by using a sensor, with a lock locking and unlocking mechanism for locking and/or unlocking a window of a building comprising:
a stand fitted into a hole opened in one window frame;
a lock section constituted by a lock body provided at this stand;
a lock piece engaging with the lock section provided at the remaining frame; and
a first controller for moving the lock piece, with the lock locking and unlocking mechanism actuated by operation of the first controller so as to lock and unlock the window,
and with a window opening and closing mechanism for opening and/or closing the window comprising:
a driven section provided at one window;
a main drive section provided at a window frame;
a drive section for driving the main drive section;
stopping means for stopping the drive section; and
a second controller actuating the drive section, provided so as to open and close the window as a result of operating the second controller so as to actuate the drive section and main drive section.

2. An automatic opening and closing system for opening and closing a window by automatically locking and/or unlocking a lock section of the window and by using a sensor, with a lock locking and unlocking mechanism for locking and/or unlocking a window of a building comprising:
a stand fitted into a hole opened in one window frame;
a lock section constituted by a lock body provided at this stand;
a lock piece engaging with the lock section provided at the remaining frame; and
a first controller for moving the lock piece, with the lock locking and unlocking mechanism actuated by operation of the first controller so as to lock and unlock the window,
and with a window opening and closing mechanism for opening and/or closing the window comprising:
a fitting lug body fitted to the frame, a stopping lug provided at the fitting lug body, a drive section such as a motor capable of forward and reverse motion provided at the fitting lug body;
a transmission mechanism provided at the drive section;
a drive section body driven by the transmission mechanism and coming into contact with the window frame; and
a second controller for actuating the drive section,
with the drive section being actuated by operation of the second controller so as to open and close the window.

3. An automatic opening and closing system for opening and closing a window by automatically locking and/or unlocking a lock section of the window and by using a sensor, with a lock locking and unlocking mechanism for locking and/or unlocking a window of a building comprising:
a stand fitted into a hole opened in one window frame;
a lock section constituted by a lock body provided at this stand;
a lock piece engaging with the lock section provided at the remaining frame; and
a first controller for moving the lock piece, with the lock locking and unlocking mechanism actuated by operation of the first controller so as to lock and unlock the window,
and with a window opening and closing mechanism for opening and/or closing the window comprising:
a fitting lug body equipped with a pair of projection sections fitted at the frame;
a stopping lug provided at the fitting lug body, a drive section of a motor provided at the fitting lug body capable of rotating forwards and in reverse;
a transmission mechanism provided at this drive section, a drive section body driven by the transmission mechanism and coming into contact with the window frame; and
a second controller actuating the drive section, wherein the fitting lug body is fixed to the window frame by inserting one projection section of the fitting lug body into a gap formed between the frame and the window frame and fastening a stopping lug provided at the other projection section to the frame, and the drive section is actuated by operation of the second controller so that a window is opened and closed.

4. An automatic opening and closing system for opening and closing a window by automatically locking and/or unlocking a lock section of the window and by using a sensor, wherein the window opening and closing mechanism as disclosed in any one of claim 1 to claim 3 is a configuration functioning as a rainwater sensor arranged outside of a room, a temperature sensor or a wind sensor in a room, or a controller operated by remote operation, with a drive section constituting the window opening and closing mechanism being actuated under the command of the control section, so that the window is opened and closed.

5. An automatic opening and closing system for opening and closing a window by automatically locking and/or unlocking a lock section of the window and by using a sensor, wherein the lock locking and unlocking mechanism disclosed in any one of claim 1 to claim 3 is configured so as to be controlled by a lock sensor provided at the window glass, or by automatic means such as remote operation, with the lock piece being actuated via this controller.

6. An automatic opening and closing system for opening and closing a window by automatically locking and/or unlocking a lock section of the window and by using a sensor, wherein a vibration sensor is provided for the window disclosed in any one of claim 1 to claim 3, with alarm means being actuated by the operation of this vibration sensor.

7. An automatic opening and closing system for opening and closing a window by automatically locking and/or unlocking a lock section of the window and by using a sensor, wherein the window opening and closing mechanism disclosed in claim 1 comprises a motor capable of rotating forwards and backwards, a resilient body with a motor pulley wrapped around, a first gear with the resilient body wrapped around, a second gear meshing with the first gear, a third gear meshing with the second gear, and a ratchet with spring stopped at the third gear, wherein, after the window is opened to a fixed position, the third gear is restricted by the ratchet so as to stop the window in a fixed position, restriction of the ratchet and the third gear is released by a sensor such as the rainwater sensor or temperature sensor so as to enable the window to be moved in a closing direction by reaction force of the spring.

8. An automatic opening and closing system for opening and closing a window by automatically locking and/or unlocking a lock section of the window and by using a sensor, wherein the window opening and closing mechanism disclosed in claim 1 comprises a motor capable of forward and reverse rotation, an extending and retracting rod linked to this motor capable of extending and retracting due to rotation of the motor, and a window fitting section at the extending and retracting rod, wherein, after the window is opened to a fixed position, rotation of the motor is stopped, the window is stopped at a fixed position, and it is possible to move the window in a closing direction by extension and retraction of the rod using sensors such as the rainwater sensor and temperature sensor.

9. An automatic opening and closing system for opening and closing a window by automatically locking and/or unlocking a lock section of the window and by using a sensor, wherein the window opening and closing mechanism disclosed in claim 1 comprises a motor capable of forward and reverse rotation, a pinion capable of forward and reverse rotation by the motor, and a rack provided at the window meshing with the pinion, wherein after opening of the window to a fixed position using positive rotation of the pinion, rotation of the motor is stopped so that the window is stopped at a fixed position, and the window can be moved in a closing direction through reverse rotation of the pinion due to rotation of the motor using a sensor such as the rainwater sensor, or temperature sensor.

10. An automatic opening and closing system for opening and closing a window by automatically locking and/or unlocking a lock section of the window and by using a sensor, wherein the window opening and closing mechanism disclosed in claim 1 comprises a motor capable of forward and reverse rotation, a screw shaft linked to the motor, a support section screwed together with the screw shaft, and a window fitting section arranged at the support section, wherein, after the window is opened to a fixed position using forward rotation of the screw shaft through rotation of the motor, and after rotation of the motor is stopped to that the window is stopped at a fixed position, the window can be moved in a closing direction using reverse rotation of the screw shaft due to rotation of the motor using sensors such as the rainwater sensor and temperature sensor.

11. An automatic opening and closing system for opening and closing a window by automatically locking and/or unlocking a lock section of the window and by using a sensor, wherein the window opening and closing mechanism disclosed in claim 1 comprises a motor capable of forward and reverse rotation, a pulley linked to the motor, a belt wrapped around the rollers, another pulley around which the belt wraps and a window fitting section provided at the belt, wherein, after the window is opened to a fixed position using forward rotation of the belt through rotation of the motor, and after rotation of the motor is stopped to that the window is stopped at a fixed position, the window can be moved in a closing direction using reverse rotation of the belt due to rotation of the motor using sensors such as the rainwater sensor and temperature sensor.

12. An automatic opening and closing system for opening and closing a window by automatically locking and/or unlocking a lock section of the window and by using a sensor, wherein the window opening and closing mechanism disclosed in claim 1 comprises a first magnet on one side, a second magnet on another side, and a mechanism for NS polarity switching supplying and ceasing supply of electricity to the first magnet, wherein after electricity is supplied to the first magnet so that the window is opened to a fixed position, when an instruction is given to the window opening and closing mechanism using a sensor such as the rainwater sensor and temperature sensor, and the supply of electricity to the first magnet is stopped, the window can be moved in a closing direction.

13. An automatic opening and closing system for opening and closing a window by automatically locking and/or unlocking a lock section of the window and by using a sensor, wherein the drive section body disclosed in claim 2 or claim 3 is means capable of being connected to and distanced from the window frame.
